(19) United States
(12) Patent Application Publication
(10) Pub. No.: US 2018/0131676 A1
(43) Pub. Date: May 10, 2018

(54) CODE ENCRYPTION

(71) Applicant: TELEFONAKTIEBOLAGET LM ERICSSON (PUBL), Stockholm (SE)

(72) Inventors: Vesa TORVINEN, Turku (FI); Vesa LEHTOVIRTA, Jorvas (FI); Katharina PFEFFER, Graz (AT); Monica WIFVESSON, Lund (SE)

(73) Assignee: TELEFONAKTIEBOLAGET LM ERICSSON (PUBL), Stockholm (SE)

(21) Appl. No.: 15/566,062

(22) PCT Filed: Feb. 4, 2016
(86) PCT No.: PCT/EP2016/052358

§ 371 Date: Oct. 12, 2017

Related U.S. Application Data
(60) Provisional application No. 62/146,600, filed on Apr. 13, 2015.

(51) Int. Cl. H04L 29/06; H04L 9/06; H04L 9/32; H04W 12/02

(52) U.S. Cl. CPC H04L 63/0414; H04L 9/06; H04W 8/005; H04W 12/02; H04L 2209/04; H04L 9/3234

(57) ABSTRACT

A device receives a privacy template from a network node. The device forms a temporary privacy mask using a time-varying value and the privacy template; and encrypts a code value using the temporary privacy mask. The device transmits the encrypted code value. A receiving device receives an encrypted code value, and forms a temporary privacy mask using a time-varying value and a privacy template that it has also received from a network node. The receiving device is then able to decrypt the code value using the temporary privacy mask. The code may identify an individual or a group, and may be protected using a privacy template that is specific to the individual or to the group.

### TECHNICAL FIELD

This relates to encryption of a code. In certain examples, the code is a ProSe (Proximity Services) code, transmitted by wireless communications devices.

### BACKGROUND

Proximity Services (ProSe) are services that can be provided by the 3GPP system based on UEs being in proximity to each other. One of these services is ProSe Discovery. The ProSe service is described in 3GPP TS 22.278 and 3GPP TS 23.303.

ProSe Discovery identifies that ProSe-enabled UEs are in proximity of each other, using evolved UMTS Terrestrial Radio Access (E-UTRA), whether or not they are using the evolved UMTS Terrestrial Radio Access Network (E-UTRAN) or the Extended Packet Core (EPC) network, when permission, authorization and proximity criteria are fulfilled. The proximity criteria can be configured by the operator.

The ProSe Discovery process involves a discovery message being sent by one device, and received by another. The discovery message sent by a device includes an identifier. However, if the device sends the same message repeatedly, an unauthorized third party may be able to track the device. To mitigate against this attack, the ProSe identifiers broadcast over the air by a device should change periodically, in a manner not easily predictable by any passive receiver. Devices that have been authorized to discover a particular device are able to understand the next ProSe identifier used by that particular device.

3GPP TR 33 describes one solution to this, and this solution involves generating a new temporary ID value, based on the ProSe Code associated with the transmitting device, each time that the device sends a discovery message. Receiving devices are able to generate temporary ID values in the same way, based on the ProSe Codes that are of interest to them. Thus, any device that receives a discovery message containing a temporary ID can compare it to locally-generated temporary ID values, corresponding to all of the ProSe Codes that are of interest to it. The receiving device will be able to generate a temporary ID value that is equal to the temporary ID value generated by the transmitting device, and so it will be able to recognize that the comparison has produced a match, and will be able to recognize the device that transmitted the discovery message.

However, ProSe Codes can also be used for encoding group information. For example, a ProSe Code may identify both the identity of the associated device, and the organization or group that that device belongs to. A device that receives the discovery message may know the part of the code that is associated with the group, but not know the identity of the individual device.

In that situation, the receiving device may not have exactly the same information that was contained in the ProSe Code used to generate the temporary ID value in the transmitting device. In this case, the receiving UE may not be able to generate a temporary ID value that matches the temporary ID value generated by the transmitting device, and so it will not be able to recognize the device that transmitted the discovery message.

### SUMMARY

According to a first aspect of the invention, there is provided a method, comprising forming a temporary privacy mask using a time-varying value and a privacy template. The method further comprises encrypting a code value using the temporary privacy mask; and transmitting the encrypted code value.

The time-varying value may be a counter, and more specifically may be a time-based counter, and still more specifically may be a UTC-based counter. Alternatively, the time-varying value may be a Message Integrity Code associated with the code value.

The method may comprise, as a preliminary step, receiving the privacy template. The privacy template may be received from a network node, which may be a ProSe function node or a ProSe Application Server, as examples.

In some embodiments, the method comprises forming the temporary privacy mask by applying a hash function to the counter value and the privacy template.

The code value may be a ProSe code.

In some embodiments, the method comprises encrypting the code value using the temporary privacy mask by performing an XOR operation on the code value and the temporary privacy mask.

In some embodiments, the method comprises encrypting a part of the code value and leaving a part of the code value unencrypted. As an example, a PLMN identifier of the code value may be left unencrypted.

In some embodiments, the method comprises transmitting with the encrypted code value a flag indicating that at least a part of the code value is encrypted.

The code may identify an individual, while the code is confidentiality protected using the privacy template specific to the individual.

The code may identify an individual, while the code is confidentiality protected using the privacy template specific to a group.

The code may identify a group, while the code is confidentiality protected using the privacy template specific to the group.

The code may identify both a group and an individual, while the code is confidentiality protected using the privacy template specific to the individual.

The code may identify both a group and an individual, while the code is confidentiality protected using the privacy template specific to the group.

The code may identify both a group and a subgroup, while the code is confidentiality protected using the privacy template specific to the subgroup.

According to a second aspect of the invention, there is provided a user equipment device, configured to form a temporary privacy mask using a time-varying value and a privacy template. The device is further configured to encrypt a code value using the temporary privacy mask; and transmit the encrypted code value.

The device may be further configured to perform any method according to the first aspect.

According to a third aspect, there is provided a user equipment device, comprising a processor and a memory, the memory containing instructions executable by the processor, such that the user equipment device is operable to carry out a method according to the first aspect.

According to a fourth aspect, there is provided a method, comprising receiving an encrypted code value. The method further comprises forming a temporary privacy mask using a time-varying value and a privacy template; and decrypting the code value using the temporary privacy mask.

The time-varying value may be a counter, and more specifically may be a time-based counter, and still more specifically may be a UTC-based counter. Alternatively, the time-varying value may be a Message Integrity Code associated with the code value.

The method may comprise, as a preliminary step, receiving the privacy template. The privacy template may be received from a network node, which may be a ProSe function node or a ProSe Application Server, as examples.

In some embodiments, the method comprises forming the temporary privacy mask by applying a hash function to the counter value and the privacy template.

The code value may be a ProSe code.

In some embodiments, the method comprises decrypting the code value using the temporary privacy mask by performing an XOR operation on the encrypted code value and the temporary privacy mask.

In some embodiments, the method further comprises testing whether the decrypted code value is recognized by comparing at least a part of the decrypted code value with a stored code value.

In some embodiments, the method further comprises applying a mask to the decrypted code value; applying said mask to the stored code value; and determining whether the result of applying the mask to the decrypted code value matches the result of applying the mask to the stored code value.

The code may identify an individual, while the code is confidentiality protected using the privacy template specific to the individual.

The code may identify an individual, while the code is confidentiality protected using the privacy template specific to a group.

The code may identify a group, while the code is confidentiality protected using the privacy template specific to the group.

The code may identify both a group and an individual, while the code is confidentiality protected using the privacy template specific to the individual.

The code may identify both a group and an individual, while the code is confidentiality protected using the privacy template specific to the group.

The code may identify both a group and a subgroup, while the code is confidentiality protected using the privacy template specific to the subgroup.

According to a fifth aspect, there is provided a user equipment device, configured to form a temporary privacy mask using a counter value and a privacy template. The device is further configured to receive an encrypted code value; and decrypt the code value using the temporary privacy mask.

The device may be further configured to perform any method according to the fourth aspect.

According to a sixth aspect, there is provided a user equipment device, comprising a processor and a memory, the memory containing instructions executable by the processor, such that the user equipment device is operable to carry out a method according to the fourth aspect.

According to a seventh aspect, there is provided a method, comprising, in response to a discovery request from a device, sending a discovery response to the device. The discovery response includes at least one privacy template.

In some embodiments, the privacy template may be specific to an individual device. In other embodiments, the privacy template may be shared between a plurality of devices. In other embodiments, the privacy template may be specific to a group of devices.

In some embodiments, the method comprises sending the privacy template from a ProSe Function. In other embodiments, the method comprises sending the privacy template from a ProSe App Server.

According to an eighth aspect, there is provided a network node, configured to, in response to a discovery request from a device, send a discovery response to the device. The discovery response includes at least one privacy template.

The network node may be a ProSe Function, or may be a ProSe App Server.

According to a ninth aspect, there is provided a network node, comprising a processor and a memory, the memory containing instructions executable by the processor, such that the network node is operable to carry out a method according to the seventh aspect.

According to a tenth aspect, there is provided a computer program configured, when run on a computer, to carry out a method according to any one of the first, fourth or seventh aspects.

According to a further aspect, there is provided a computer program product comprising computer readable medium and a computer program according to the tenth aspect stored on the computer readable medium.

### BRIEF DESCRIPTION OF THE DRAWINGS

FIG. 1 illustrates a first network operating in accordance with an embodiment of the invention;

FIG. 2 illustrates a second network operating in accordance with an embodiment of the invention;

FIG. 3 illustrates the form of the network;

FIG. 4 illustrates a message format;

FIG. 5 illustrates a first method;

FIG. 6 illustrates a second method;

FIG. 7 illustrates a third method;

FIG. 8 illustrates a fourth method;

FIG. 9 illustrates a fifth method;

FIG. 10 illustrates a sixth method;

FIG. 11 illustrates a seventh method;

FIG. 12 illustrates an eighth method;

FIG. 13 is a flow chart illustrating process steps in a first method performed by a UE;

FIG. 14 is a flow chart illustrating process steps in a second method performed by a UE;

FIG. 15 is a flow chart illustrating process steps in a method performed by a network node;

FIG. 16 is a block diagram illustrating a UE;

FIG. 17 is a block diagram illustrating a network node;

FIG. 18 is a block diagram illustrating another example of a UE;

FIG. 19 is a block diagram illustrating another example of a network node;

FIG. 20 is a block diagram illustrating another example of a UE; and

FIG. 21 is a block diagram illustrating another example of a network node.

### DETAILED DESCRIPTION

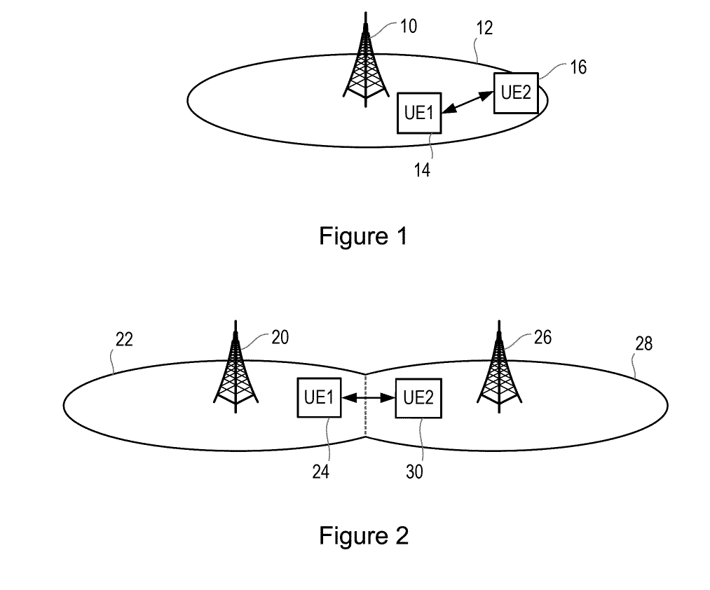

FIG. 1 illustrates a part of a cellular communications network, including a first base station 10, serving a cell 12, with a first wireless communications device (UE1) 14 and a second wireless communications device (UE2) 16 within the cell 12.

FIG. 2 illustrates a part of another cellular communications network, including a first base station 20, serving a first cell 22, with a first wireless communications device (UE1) 24 within the cell 22, and a second base station 26, serving a second cell 28, with a second wireless communications device (UE2) 30 within the cell 28.

In the examples described herein, the devices taking part in the methods are described as user equipment devices (UEs). It will be understood that this term is used to refer to user-operated portable communications devices, such as smartphones, laptop computers or the like, to other portable devices, such as tracking devices or the like, and to devices that are primarily intended to remain stationary in use, such as sensors, smart meters or the like.

In the examples shown in FIGS. 1 and 2, the networks form part of an Evolved UMTS Terrestrial Radio Access Network (E-UTRAN), as defined by the 3^{rd} Generation Partnership Project (3GPP). The 3GPP system provides the possibility of Proximity Services (ProSe) that can be used by User Equipment (UE) devices that are in proximity to each other. The ProSe system is described in 3GPP TS 22.278 and 3GPP TS 23.303. For example, the ProSe system allows the possibility of Device-to-Device (D2D) communication, without passing messages through the Radio Access Network.

One aspect of the ProSe system is the process of ProSe Discovery. The ProSe Discovery process identifies that ProSe-enabled UEs are in proximity of each other, using Evolved UMTS Terrestrial Radio Access (with or without using the E-UTRAN) or the Extended Packet Core (EPC) network, when permission, authorization and proximity criteria are fulfilled. The proximity criteria can be configured by the operator. One specific form of ProSe Discovery is ProSe Direct Discovery, which is a procedure employed by a ProSe-enabled UE to discover other ProSe-enabled UEs in its vicinity by using only the capabilities of the two UEs with E-UTRA technology.

The term ProSe-enabled UE refers to a UE that supports ProSe requirements and associated procedures. A ProSe-enabled UE may be either a non-Public Safety UE and/or a Public Safety UE.

FIGS. 1 and 2 show scenarios for D2D ProSe where UE1 and UE2 are each located in coverage of a cell, which may be the same cell 12 as shown in FIG. 1, or may be different cells 22, 28 as shown in FIG. 2. When UE1 has a role as a transmitter, UE1 sends a discovery message and UE2 receives it. The two devices UE1 and UE2 can change their roles as transmitter and receiver. The transmission from UE1 can be received by at least one other UE in addition to UE2.

The ProSe Discovery process can be used as a standalone process (i.e. it is not necessarily followed by ProSe Communication) or as an enabler for other services.

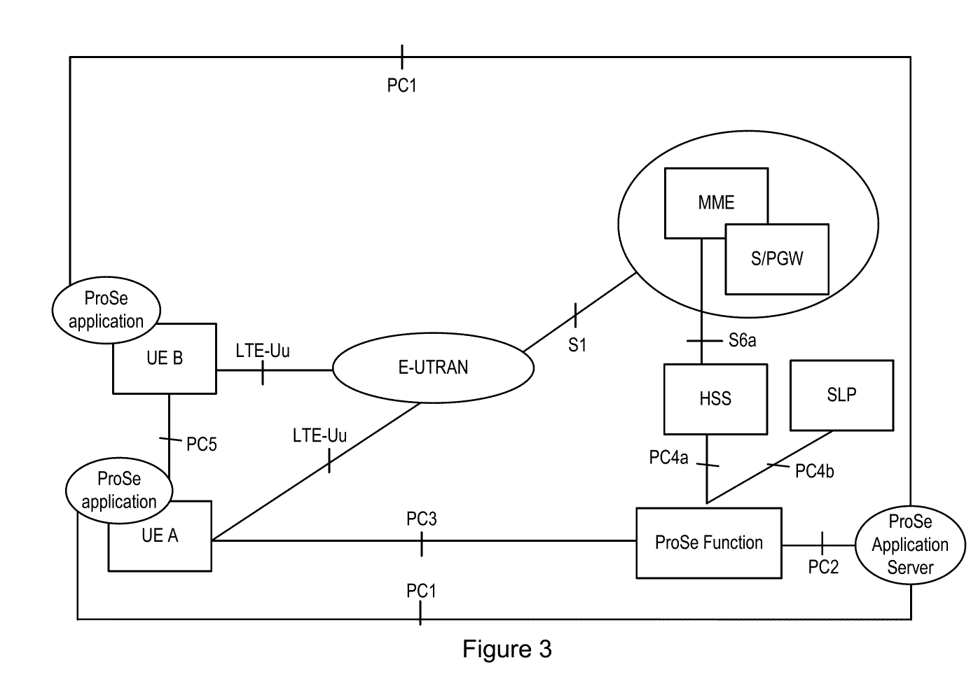

FIG. 3 is an illustration of the ProSe network architecture. In FIG. 3, it is assumed that two user equipment devices, UE A and UE B, subscribe to the same Public Land Mobile Network (PLMN).

The two user equipment devices, UE A and UE B, each have a respective connection over the LTE-Uu interface to the Evolved UMTS Terrestrial Radio Access Network (E-UTRAN). An S1 interface connects the E-UTRAN to an Evolved Packet Core (EPC) network, which includes a Mobility Management Entity (MME), Serving Gateway (SGW), Packet Gateway (PGW), Home Subscriber Server (HSS), and Secure User Plane Location (SUPL) Location Platform (SLP), amongst other network nodes.

The network also includes at least one Application server, which uses the ProSe capability for building the application functionality.

The core network also includes a ProSe Function, which provides functionality such as: Authorization and configuration of the UE for discovery and direct communication (controlled by the ProSe Function in the user's Home PLMN in the non-roaming case and by the Home PLMN or Visited PLMN ProSe Function in the roaming case); enabling the functionality of the EPC level ProSe discovery; handling and storing of ProSe related new subscriber data and ProSe identities; and security related functionality.

The ProSe Function has a PC3 reference point towards each UE, and has a PC4 reference point towards the EPC.

The ProSe Function also has a PC2 reference point towards at least one ProSe Application Server, which uses the ProSe capability for building the application functionality.

Each UE includes a ProSe application, which has a PC1 reference point towards the ProSe Application Server.

The UEs UE A and UE B use the PC5 reference point for control and user plane for discovery and communication, for relay and one-to-one communication (between UEs directly and between UEs over the LTE-Uu interface).

The ProSe Discovery process involves a discovery message being sent by one device, and received by another. The discovery message sent by a device includes an identifier. However, if the device sends the same message repeatedly, an unauthorized third party may be able to track the device.

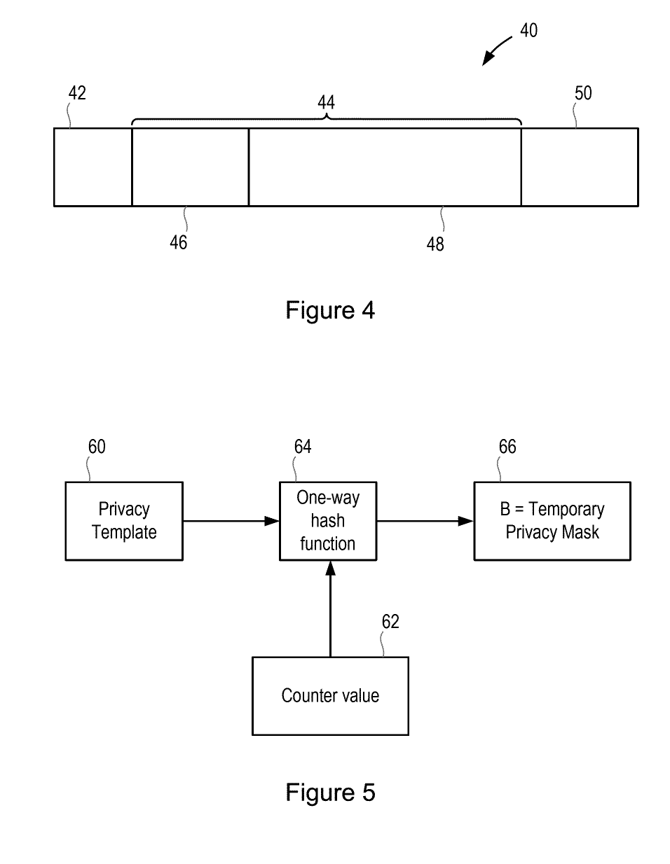

FIG. 4 illustrates a format of a discovery message to be sent by a transmitting device.

Specifically, the discovery message 40 includes an eight bit message type indicator 42. In the message type indicator 42, there are two bits that indicate the discovery type. For example, one combination of the two bits may indicate open discovery, while another combination of the two bits may indicate restricted discovery.

Also, in the message type indicator, there are two bits that indicate the discovery mode. For example, one combination of the two bits may indicate Model A discovery, in which one UE announces its presence, while another combination of the two bits may indicate Model B discovery, which involves one UE asking “who is there” and/or “are you there”.

In addition, in the message type indicator, one bit may indicate whether the message includes an encrypted code value. In the example described here, this bit is set to indicate that the message includes an at least partially encrypted code value.

As also shown in FIG. 4, the discovery message includes the code value. As mentioned above, this code value is at least partially encrypted in some embodiments. The code value field 44 contains 184 bits, with a first section 46 containing a Public Land Mobile Network (PLMN) identifier. Two bits of the first section 46 indicate the scope of the identifier. Thus, one combination of these two bits indicates a global scope, a second combination indicates a country-specific scope, and a third combination indicates a PLMN-specific scope.

A third bit of the first section 46 then indicates whether the PLMN identifier 46 contains a mobile country code (MCC) and a mobile network code (MNC). If the MCC and MNC are included, then they each contain 10 bits to identify the country or operator, respectively.

Thus, depending on whether the MCC and MNC are included, the first section 46 of the code value field 44 may contain either 3 or 23 bits. A second section 48 of the code value field 44 then contains sufficient bits to make the total length of the code value field 44 equal to 184 bits.

As shown in FIG. 4, the discovery message also includes a Message Integrity Code 50, which contains 32 bits.

FIG. 5 illustrates a first stage in a process for generating an encrypted code value. Specifically, a UE receives a Privacy Template 60. The Privacy Template 60 is a shared secret that is distributed from the network to the UE and to those other UEs with which that UE is intended to communicate.

As described in more detail below, the Privacy Template 60 may for example be distributed to the UE from the ProSe Function or from the ProSe Application Server.

In some embodiments, the UE also includes a counter, which may for example be a time counter, such as a Co-ordinated Universal Time (UTC)-based counter, which generates a counter value 62. For example, the counter may generate a new counter value 62 once per second.

When the UE wishes to transmit a discovery message, it applies the Privacy Template 60 and the current counter value 62 to a one-way hash function 64 to create a Temporary Privacy Mask 66.

In other embodiments, the counter value 62 that is used may be the Message Integrity Code 50, which is not a counter as such, but is a value that varies over time.

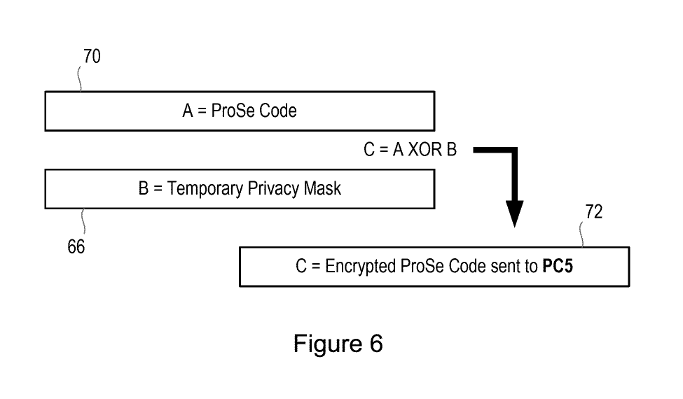

FIG. 6 illustrates a second stage in the process for generating an encrypted code value. Specifically, as described above, each UE has a ProSe Code value 70 allocated to it. For example, the length of the ProSe Code may be 184 bits. The ProSe code may identify the specific UE to which it is allocated, and may also allocate an organization or group to which that UE belongs. For example, UEs belonging to a branch of the emergency services, such as the police, may have ProSe codes that indicate this.

A ProSe Code is allocated by the ProSe Function in the HPLMN for Restricted Direct Discovery and is associated with one or more Restricted ProSe App User IDs based on the policy of the ProSe Function that allocates it. A Restricted ProSe App User ID is an identifier associated with the Application Layer User ID in the ProSe Application Server in order to hide/protect the application level user identity from the 3GPP layer. It unambiguously identifies the user within a given application.

The ProSe Code is sent by the announcing UE over the air.

The ProSe Code may be, for example, a ProSe Application Code, a ProSe Code, a ProSe Query Code or a ProSe Response Code. A ProSe Application Code is associated with the ProSe Application ID and used in the discovery procedures. A ProSe Query Code is allocated by the ProSe Function in the HPLMN to a Discoverer UE for Model B discovery. The ProSe Code is sent by the Discoverer UE over the air. A ProSe Response Code is allocated by the ProSe Function in the HPLMN to the Discoveree UE for Model B discovery. The ProSe Code is sent by the Discoveree UE over the air upon receiving a ProSe Query Code matching a Discovery Filter. A Discovery Filter is a container (opaque to the 3GPP networks) of a ProSe Application code, zero or more ProSe Application Mask(s) and Time To Live value(s). These are used by the monitoring UE to match ProSe Application Codes that are received on the PC5 interface for Direct Discovery.

As discussed with reference to FIG. 4, the ProSe code may also indicate the country and the mobile network to which the UE belongs.

A bitwise binary XOR operation is then performed on the ProSe Code value 70 and on the Temporary Privacy Mask 66 obtained in the first stage as shown in FIG. 4. In order to perform this operation across the whole length of the ProSe Code value, the Temporary Privacy Mask 66 needs to be of same length as the ProSe Code value 70. In some embodiments, the whole of the ProSe Code value is encrypted in this way.

In other embodiments, some of the ProSe Code value may not be encrypted. For example, the ProSe code may include a PLMN identifier 46 as shown in FIG. 4, indicating the country and the mobile network to which the UE belongs. In this case, the PLMN identifier, including the mobile country code (MCC) and the mobile network code (MNC), may not be encrypted.

Performing the bitwise binary XOR operation on some or all of the ProSe Code value 70 and on a Temporary Privacy Mask 66 of the appropriate length gives an encrypted ProSe code value 72.

The use of binary XOR encryption has the advantage that binary operations (specifically bitwise AND) are already part of the ProSe discovery framework.

The discovery message, including the encrypted ProSe Code value 72, is then sent over the PC5 reference point, so that it can be detected by other UEs in range.

In some embodiments, the discovery message also includes, in clear text, a part of the counter value 62 used in generating the Temporary Privacy Mask 66. For example, when the counter value 62 is a UTC-based counter value, the discovery message may also include, in clear text, the last few (for example, the last four) least significant bits of the counter value 62 used in generating the Temporary Privacy Mask 66.

When a UE receives a discovery message, it needs to take steps to identify the UE that sent that specific discovery message. Thus, a receiving UE generates its own Temporary Privacy Mask, by means of a process that is analogous with the process performed in the transmitting device.

Specifically, if the receiving UE is one with which the transmitting UE is intended to communicate, it will have received the same Privacy Template used by the transmitting UE. As in the case of the transmitting UE, the Privacy Template may for example be distributed to the receiving UE from the ProSe Function or from the ProSe Application Server.

If the transmitting UE includes a counter, then the receiving UE also includes a counter, which may for example be a time counter, such as a Co-ordinated Universal Time (UTC)-based counter, which generates a counter value. For example, the counter may generate a new counter value once per second.

When the UE wishes to decrypt the ProSe code in a received discovery message, it applies the Privacy Template and a counter value to a one-way hash function to create a Temporary Privacy Mask. For the decryption to be successful, the Temporary Privacy Mask generated in the receiving UE needs to match the Temporary Privacy Mask 66 generated in the transmitting UE.

In order for the Temporary Privacy Mask generated in the receiving UE to match the Temporary Privacy Mask 66 generated in the transmitting UE, it is necessary for the receiving UE to use the same counter value as the transmitting UE. The receiving UE may be unable to generate its Temporary Privacy Mask at exactly the same time as the transmitting UE generated the Temporary Privacy Mask 66. Therefore, the receiving UE reads the information transmitted in clear text in the discovery message (for example, the four least significant bits of the counter value 62 used in generating the Temporary Privacy Mask 66) to determine the full counter value that was used by the transmitting UE. (This assumes that the receiving UE will be generating its Temporary Privacy Mask at a time that may be later than the time at which the transmitting UE generated the Temporary Privacy Mask 66, but is later by less than the time within which these least significant bits of the counter value will repeat.)

Thus, the receiving UE can use the same counter value as the transmitting UE, and so it can generate a Temporary Privacy Mask that matches the Temporary Privacy Mask 66 generated in the transmitting UE.

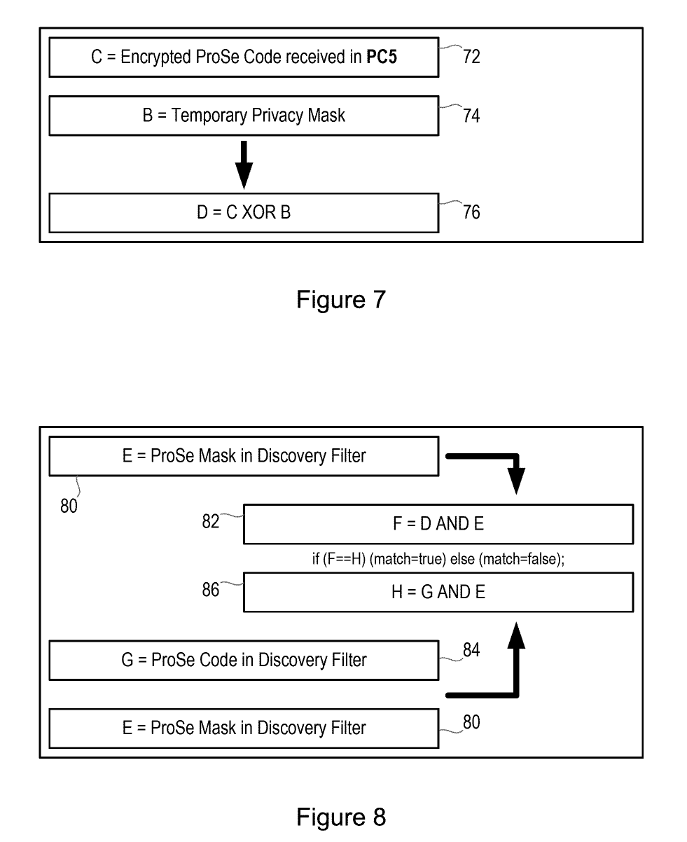

FIG. 7 illustrates the use of the Temporary Privacy Mask generated in the receiving UE.

As shown in FIG. 7, a bitwise binary XOR operation is then performed on the encrypted ProSe Code value 72 that was received in the detected discovery message and on the Temporary Privacy Mask 74 generated in the receiving UE as described above.

In order to perform this operation across the whole length of the encrypted ProSe Code value, the Temporary Privacy Mask 74 needs to be of same length as the encrypted ProSe Code value 72. In other embodiments, as described above, some of the ProSe Code value may not be encrypted. In such cases, the Temporary Privacy Mask 74 needs to be of same length as the encrypted part of the ProSe Code value 72.

Performing the bitwise binary XOR operation on some or all of the encrypted ProSe Code value 72 and on the Temporary Privacy Mask 74 of the appropriate length gives a decrypted ProSe code value 76.

In a straightforward case, the receiving UE is then able to determine from the decrypted ProSe code value 76 the identity of the transmitting UE.

More generally, FIG. 8 illustrates a case where the receiving UE uses a Discovery Filter, as described in 3GPP TS 23.303, to test the decrypted ProSe code value 76. The Discovery Filter contains a ProSe Code, and may also contain a ProSe Mask 80. The use of the ProSe Mask 80 allows the identification to be performed when the receiving UE knows only a part of the ProSe code value transmitted by the transmitting UE.

A first bitwise binary AND operation is performed on the or each ProSe Mask 80 and the decrypted ProSe code value 76 to generate a first result value 82.

A second bitwise binary AND operation is performed on the or each ProSe Mask 80 and the ProSe code value 84 in the Discovery Filter to generate a second result value 86.

If the first result value 82 matches the second result value 86, then it is determined by the receiving UE that the transmitting UE is the UE identified by the ProSe code value 84 in the Discovery Filter. Otherwise, it is determined that the transmitting UE is not the UE identified by the ProSe code value 84 in the Discovery Filter.

Thus, the identification of the code value transmitted by the transmitting UE can be performed by the receiving UE, provided that the receiving UE has the shared secret value, namely the Privacy Template.

The use of binary XOR decryption and a shared mask has the advantage that it fits well with the existing ProSe framework because masks and binary operations (bitwise AND) are already part of the discovery.

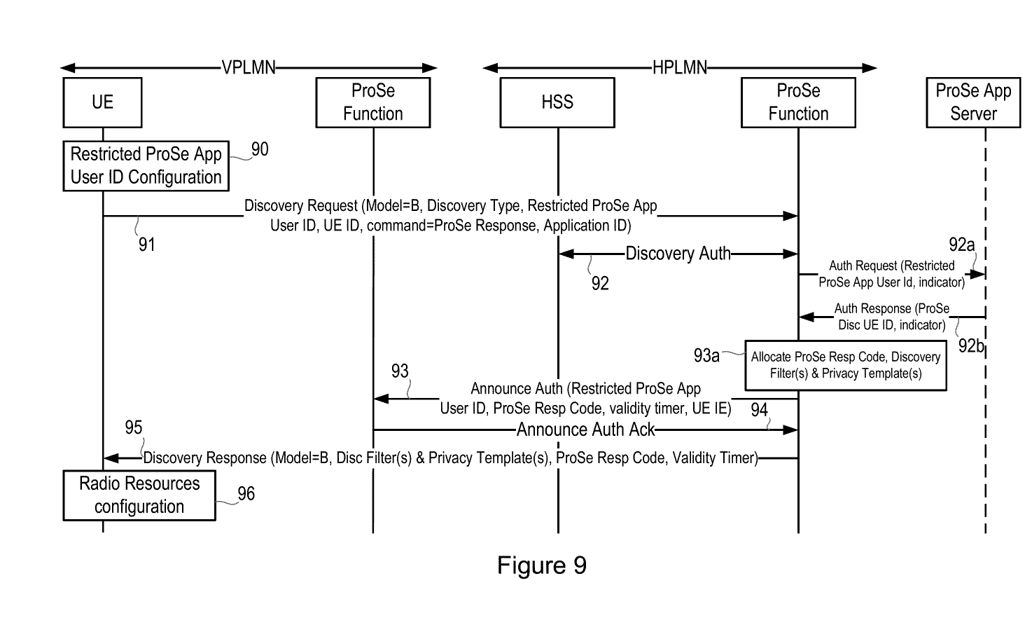

FIG. 9 illustrates a first procedure for transmitting a Privacy Template to a UE, in this case a receiving UE, or Discoveree UE.

In step 90, the Discoveree UE is configured with Restricted ProSe Application User ID.

In step 91, if the Discoveree UE is authorised to use Model B discovery in the serving PLMN, it shall establish a secure connection with the ProSe Function and send a Discovery Request (Discovery Model, Restricted ProSe Application User ID, UE Identity, command, Application ID) message. The Discovery Model indicates that Model B is used. The ProSe Application ID indicates what the UE is interested to announce. The UE Identity is set to e.g. IMSI. The command indicates that this is for ProSe Response operation, i.e. for a Discoveree UE. The Application ID represents a unique identifier of the UE application that has triggered the transmission of the Discovery Request message. This request is always sent to the ProSe Function in HPLMN.

In step 92, the ProSe Function checks for the authorization of the application represented by the Application ID. If there is no associated UE context, the ProSe Function shall check with HSS the authorisation for discovery and create a new context for this UE that contains the subscription parameters for this UE for the duration of the validity timer. The HSS provides the MSISDN of the UE. If the UE does not issue a new announce request within the duration of the validity timer the ProSe Function shall remove the entry related to the requested ProSe Application ID from the UE context.

Steps 92a and 92b may be used when the Discovery Type indicates Restricted Discovery. Thus, optionally, in step 92a, the ProSe Function sends an Auth Request (Restricted ProSe App User ID, indicator) to the ProSe Application Server. The ProSe Function locates the ProSe Application Server based on the Application ID. The indicator is set to “restricted discovery/announce”. In step 92b, the ProSe Application Server returns an Auth Response (ProSe Discovery UE ID, indicator) message. The ProSe Discovery UE ID is a temporary identifier assigned by the ProSe Function in the HPLMN to the UE for the restricted direct discovery service. It includes the PLMN ID and a temporary identifier that uniquely identifies the UE in the HPLMN. It corresponds to the Restricted ProSe App User ID stored in the ProSe Application Server. The indicator is set to “restricted discovery/announce ack”.

In step 93a, the ProSe Function allocates a ProSe Response Code, a ProSe Discovery Filter, and one or more Privacy Templates.

In step 93, if the Discovery Request is authorised then the HPLMN ProSe Function shall inform the ProSe Function in VPLMN with the Announce Authorisation (Restricted ProSe Application User ID, Application ID, ProSe Response Code, validity timer, UE Identity) message. The Restricted ProSe Application User ID corresponds to the request from the UE, whereas the ProSe Response Code indicates the assigned code for this request. The request also includes the UE identity information e.g. IMSI or MSISDN in order to allow the ProSe Function in VPLMN to perform charging. The validity timer indicates for how long this ProSe Response Code is going to be valid.

In step 94, the ProSe Function in VPLMN authorizes the UE to perform ProSe Direct Discovery announcing.

In step 95, the ProSe Function in HPLMN responds with a Discovery Response (Discovery Model, Discovery Filter and Privacy Template(s), ProSe Response Code, validity timer) message. The Discovery Model indicates that Model B is used. Multiple Discovery Filters may be returned. The Discovery Filter provides the filter for the Discoveree UE to determine if a received ProSe Query Code over the air should trigger sending of the ProSe Response Code. The ProSe Response Code is provided by the ProSe Function and corresponds to the Restricted ProSe Application User ID that was contained in the Discovery Request. The validity timer indicates for how long this ProSe Response Code is going to be valid. When the validity timer expires or the UE changes its registered PLMN, the UE needs to request a new ProSe Response Code.

In step 96, the UE may start to obtain the radio resources to monitor using the Discovery Filter, as authorised and configured by E-UTRAN for ProSe as defined in RAN specifications.

Thus, the UE receives the Privacy Template or Templates.

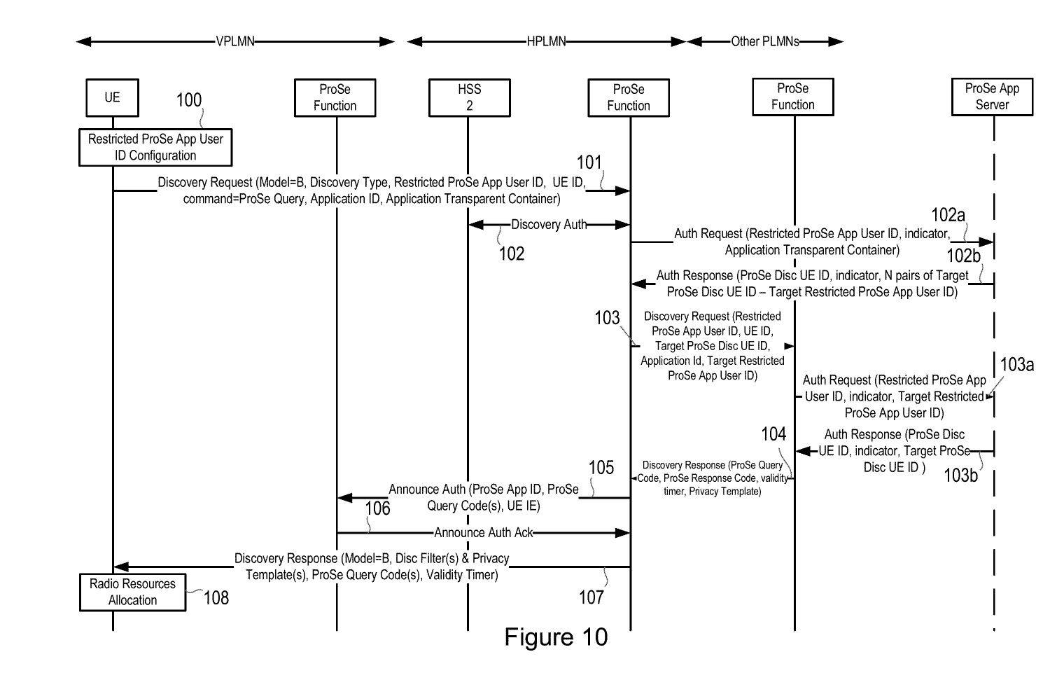

FIG. 10 illustrates a second procedure for transmitting a Privacy Template to a UE, in this case a transmitting UE, or Discoverer UE.

In step 100, the Discoverer UEs are configured with Restricted ProSe Application User IDs.

In step 101, if the Discoverer UE is authorised to use Model B discovery in the serving PLMN, it shall establish a secure connection with the ProSe Function and send a Discovery Request (Discovery Model, Discovery Type, Restricted ProSe Application User ID, UE Identity, command, Application ID, Application Transparent Container) message. The Discovery Model indicates that Model B is used. The command indicates this is for ProSe Query operation, i.e. for a Discoverer UE. The UE Identity is set to e.g. IMSI. The Application ID represents a unique identifier of the UE application that has triggered the transmission of the Discovery Request message. This request is always sent to the ProSe Function in HPLMN.

In step 102, the ProSe Function checks for the authorization of the application represented by the Application ID. If there is no associated UE context, the ProSe Function shall check with HSS the authorisation for discovery and create a new context for this UE that contains the subscription parameters for this UE for the duration of the validity timer. The HSS provides the MSISDN of the UE. If the UE does not issue a new announce request within the duration of the validity timer the ProSe Function shall remove the entry related to the requested ProSe Application ID from the UE context.

Steps 102a and 102b may be used when the Discovery Type indicates Restricted Discovery. Thus, optionally, in step 102a, the ProSe Function sends an Auth Request (Restricted ProSe App User ID, indicator) to the ProSe Application Server. The ProSe Function locates the ProSe Application Server based on the Application ID. The indicator is set to “restricted discovery/announce”. In step 102b, the ProSe Application Server returns an Auth Response (ProSe Discovery UE ID, indicator) message. The ProSe Discovery UE ID corresponds to the Restricted ProSe App User ID stored in the ProSe Application Server. The indicator is set to “restricted discovery/announce ack”.

In step 103, if the Discovery Request is authorized, and the PLMN ID in the Target ProSe Discovery UE ID indicates a different PLMN, the ProSe Function contacts the indicated PLMN's ProSe Function to obtain the necessary information with a Discovery Request (Restricted ProSe App User ID, UE Identity, Target ProSe Discovery UE ID, Application ID, Target Restricted ProSe App User ID).

Optionally, in step 103a, the ProSe Function in the other PLMN sends an Auth Request (Restricted ProSe App User ID , indicator, Target Restricted ProSe App User ID) to the Application Server indicated by the Application ID. The indicator is set to “restricted discovery/permission”. In step 103b, if, based on the permission setting, the Restricted ProSe App User ID is allowed to discover the Target Restricted ProSe App User ID, the ProSe Application Server acknowledges the Auth Request with an Auth Response (Target ProSe Discovery UE ID, indicator). The indicator is set to “restricted discovery/permission ack”. The ProSe Function in the other PLMN verifies that the returned Target ProSe Discovery UE ID corresponds to the UE to be monitored.

In step 104, based on the Target ProSe Discovery UE ID, Application ID, and Target Restricted ProSe App User ID, the ProSe Function locates the Discoveree UE(s) context, and responds with a Discovery Response (ProSe Query Code(s), ProSe Response Code, validity timer, and Privacy Template). The ProSe Query Code is the code used by the ProSe Function to build the Discovery Filter, such that it can trigger the Discoveree UE to send the response. The ProSe Response Code is that allocated to the Discoveree UE. The validity timer indicates for how long a ProSe Query Code and ProSe Response Code are going to be valid.

In step 105, the HPLMN ProSe Function shall inform the ProSe Function in VPLMN with the Announce Authorisation (Restricted ProSe Application User ID, Application ID, ProSe Query Code(s), validity timer, UE Identity) message. The Restricted ProSe Application User ID corresponds to the request from the UE, whereas the ProSe Query Code is that obtained in step 104. The request also includes the UE identity information e.g. IMSI or MSISDN in order to allow the ProSe Function in VPLMN to perform charging. The validity timer indicates for how long this ProSe Query Code is going to be valid.

In step 106, the ProSe Function in VPLMN authorizes the UE to perform ProSe Direct Discovery announcing.

In step 107, the ProSe Function shall respond with a Discovery Response (Discovery Model, Discovery Filter(s) and Privacy Template(s), ProSe Query Code(s), validity timer) message. The Discovery Model indicates the model B is used. Multiple Discovery Filters may be returned. The Discovery Filter is generated by the ProSe Function based on the ProSe Response Code of step 104. The ProSe Query Code is that received in step 104. The validity timer indicates for how long a ProSe Query Code and Discovery Filter pair are going to be valid. When the validity timer expires the UE needs to request a new ProSe Query Code and Discovery Filter.

In step 108, the UE may start to obtain the radio resources to announce the ProSe Query Code, as authorised and configured by E-UTRAN for ProSe as defined in RAN specifications.

Thus, the discoverer UE receives the Privacy Template(s).

As described above, the Privacy Templates may be distributed via the network. Although examples of this are shown in FIGS. 9 and 10, the exact entity responsible for the distribution can be different to that shown, and may for example be either the ProSe function or the ProSe Application Server. All members of a transmitting/receiving group should have the same Privacy Template. It should also be noted that FIGS. 9 and 10 describe only one relevant Discovery Request variant, namely the co-called Restricted Direct Discovery Model B, however, there already exists also Restricted Direct Discovery Model B, Open Direct Discovery Models A and B, and public safety and commercial variants, and suitable modifications to these can be used to distribute the Privacy Template(s).

Thus, in certain examples, ProSe Codes are encrypted using a Temporary Privacy Mask (that is generated from a Privacy Template and a changing counter) using a bitwise XOR operation. The receiving ProSe UE does not need to know the original ProSe Code in order to decrypt the message. One Discovery Filter can discover several different ProSe Codes. If all members of the group share the same Privacy Template, they are able to protect the identity information related to the ProSe Codes, and still use the multi-purpose Discovery Filters.

Privacy Templates can be made Discovery Filter specific. This means that ProSe Codes can be encrypted separately to a Discovery Filter specific subgroups while the ProSe Codes themselves remains the same. Examples of such subgroup could be e.g. a) all members of an organization and b) all members of the management team of the same organization. Members outside the management team are not able to see the Discovery Requests of the management team even if they know the ProSe Codes related to the management team.

Thus, the methods described herein can be used between ProSe UEs that belong to the same group, and who needs to discover group members. This is especially important in Public Safety where e.g. a police officer wants to discover other members of the police organization without outsiders knowing that someone is looking for a member of the police organization.

The codes may identify an individual or a group, and the privacy template used to protect the code may be specific to that individual or may apply to the hole group.

In one example, the code identifies an individual and the code is confidentially protected using the privacy template specific to the individual.

In another example, the code identifies an individual and the code is confidentially protected using the privacy template specific to a group.

In a further example, the code identifies a group and the code is confidentially protected using the privacy template specific to the group.

In a further example, the code identifies both a group and an individual and the code is confidentially protected using the privacy template specific to the individual.

In a still further example, the code identifies both a group and an individual and the code is confidentially protected using the privacy template specific to the group.

In a still further example, the code identifies both a group and a subgroup and the code is confidentially protected using the privacy template specific to the subgroup.

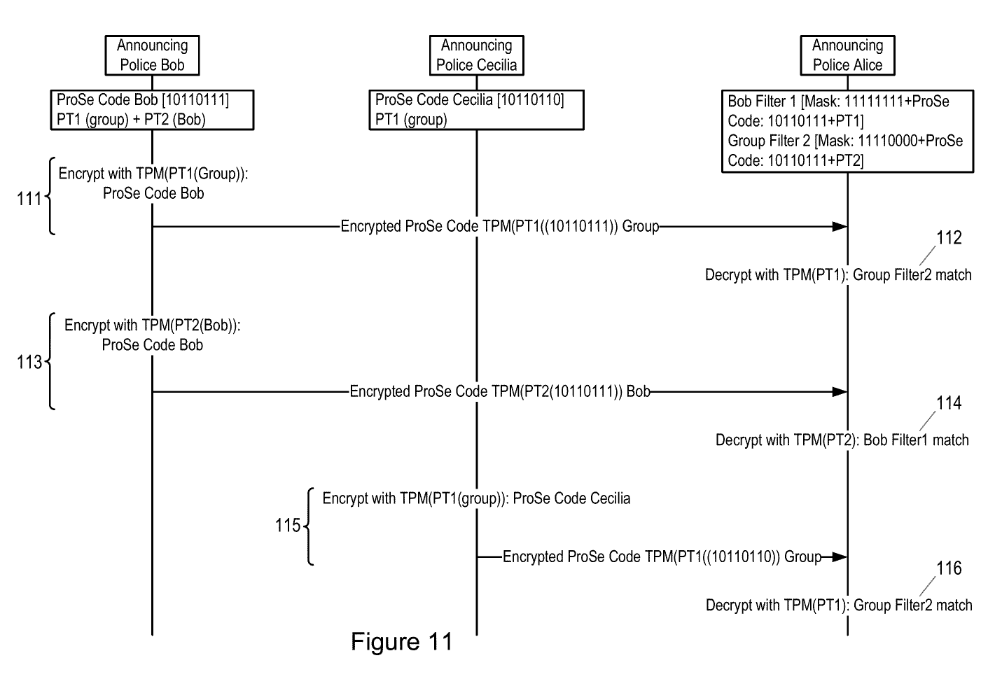

FIG. 11 illustrates one embodiment of the invention in the context of Restricted Direct Discovery Model A. In this example, the ProSe Code can be encrypted/decrypted using the Temporary Privacy Mask (TPM) that is derived from a Privacy Template (PT).

There is a first Announcing UE (Police Bob), which has received a ProSe Code identifying both the individual user's identity (Bob) and his organization (police). In FIG. 11, this ProSe Code is represented by the 8-bit value 10110111 for illustrative purposes only. He also has two Privacy Templates, PT1 related to group announcements (which can be interpreted as “A police officer is in proximity!”), and PT2 for announcements explicitly related to himself (which can be interpreted as “Bob the police is in proximity!”).

A second Announcing UE (Police Cecilia) has also received a ProSe Code identifying both her identity (Cecilia) and her organization (police). In FIG. 11, this ProSe Code is represented by the 8-bit value 10110110 for illustrative purposes only. Cecilia has only one Privacy Template PT1 that is related to group announcements only, i.e. announcements that can be interpreted as “A police officer is in proximity!”.

A Monitoring UE (Police Alice) has received two corresponding Discovery Filters, one for any police officer, and another explicitly for Bob. The first Discovery Filter is represented in FIG. 11 by the mask 11111111+the ProSe Code 10110111+PT1. The second Discovery Filter is represented in FIG. 11 by the mask 11110000+the ProSe Code 10110111+PT2.

There are two Privacy Templates.

The first Privacy Template PT1 is related to group announcements only. PT1 can be shared between all members of the group that announce or monitor the ProSe Codes related to the same group. In FIG. 11, Bob, Cecilia and Alice all have PT1. Decryption of the ProSe Codes is successful even if the monitoring UE did not know the full ProSe Codes of the announcer.

The second Privacy Template PT2 is related to announcements from Bob only. PT2 can be shared between Bob and everyone who monitors Bob using the same ProSe Code, which includes Alice in FIG. 11.

The ProSe Code belonging to Bob is related to two Discovery Filters, and consequently can be encrypted using a TPM derived either from PT1 or PT2.

FIG. 11 shows a first example, in which Bob sends a Group announcement 111, after encrypting his ProSe Code with TPM(PT1). This ProSe Code informs receivers both that there is a police announcing, and that this police is Bob. As shown at 112, Alice can decrypt this using TPM(PT1) and using the second Discovery Filter shown in FIG. 11, namely the Group Filter.

FIG. 11 also shows a second example, in which Bob sends an individual announcement 113, after encrypting his ProSe Code with TPM(PT2). As shown at 114, Alice is able to decrypt this because she has TPM(PT2). Thus, she requires the Privacy Template TP2 that is specific to Bob, in order to discover Bob.

FIG. 11 also shows a third example, in which Cecilia sends a Group announcement 115, after encrypting her ProSe Code with TPM(PT1). As shown at 116, Alice can decrypt this using TPM(PT1) and using the second Discovery Filter shown in FIG. 11, namely the Group Filter. The ProSe Code belonging to Cecilia is related to the group Discovery Filter only, and so it must be encrypted using the group specific Privacy Template, i.e. TP1. Alice is able to discover Cecilia even when she does not know the ProSe Code of Cecilia.

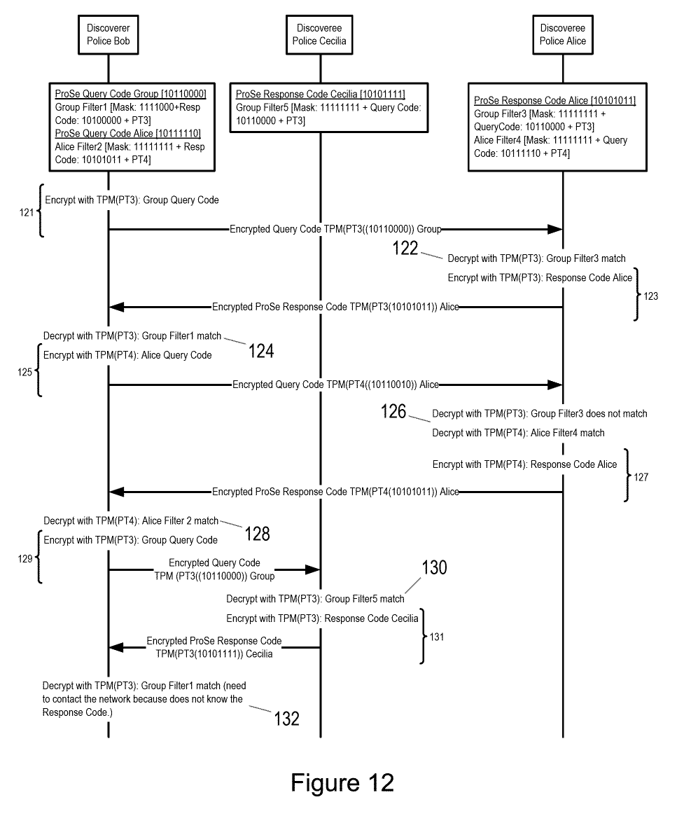

FIG. 12 illustrates another embodiment of the invention in the context of Restricted Direct Discovery Model B. In this example, both the Query Code and Response Code can be encrypted/decrypted using the Temporary Privacy Mask (TPM) derived from a Privacy Template (PT).

A first Discoveree (Police Alice) has received a Response Code identifying both her identity (Alice) and her organization (police). In FIG. 12, this Response Code is represented by the 8-bit value 10101011 for illustrative purposes only. She also has two Discovery Filters, one related to group related queries (which can be interpreted as “Any police officer in proximity?”), and another explicitly related to her (which can be interpreted as “Is Alice the police in proximity?”).

A second Discoveree (Police Cecilia) has received a Response Code identifying both her identity (Cecilia) and her organization (police). In FIG. 12, this Response Code is represented by the 8-bit value 10101111 for illustrative purposes only. She has only one Discovery Filter that is related to group related queries (which can be interpreted as “Any police officer in proximity?”).

A Discoverer (Police Bob) has received two Query Codes, one for querying police officers, and another for querying explicitly Alice. In FIG. 12, the first of these Response Codes is represented by the 8-bit value 10110000, and the second of these Response Codes is represented by the 8-bit value 10111110 for illustrative purposes only.

There are two Privacy Templates.

A first Privacy Template PT3 is related both to the Group Query Code, and related Group Discovery Filters 1, 3 and 5. PT3 can be shared between all members of the group that use the same Group Query Code.

A second Privacy Template PT4 is related both to the Alice Query Code, and related Alice Discovery Filters 2 and 4. PT4 can be shared between Alice and all her Discoverers.

The Response Code of Alice (Discoveree) is related to two Discovery Filters, and consequently can be encrypted using a TPM derived either from PT3 or PT4.

Thus, if Bob sends the Group Query Code encrypted with PTM(PT3), as shown at step 121, Alice can decrypt this with TPM(PT3) and Group Filter 3 at step 122, and at step 123 can send a Response Code that is also encrypted with TPM(PT3). Bob can then decrypt this with TPM(PT3) and Group Filter 1 at step 124.

If Bob sends the Alice Query Code encrypted with PTM(PT4), as shown at step 125, Group Filter 3 would not match, making Alice unable to decrypt this with TPM(PT3). However, at step 126, Alice can decrypt this with TPM(PT4) and the Alice Filter 4. At step 127, Alice can send a Response Code that is also encrypted with TPM(PT4). Bob can then decrypt this with TPM(PT4) and Group Filter 2 at step 128. If Bob sends the Group Query Code encrypted with PTM(PT3), as shown at step 129, Cecilia can decrypt this with TPM(PT3) and Group Filter 5 at step 130. At step 131, Cecilia can send a Response Code that is also encrypted with TPM(PT3). Bob can then decrypt this with TPM(PT3) and Group Filter 1 at step 132, but does not know Cecila's Response Code. Thus, Cecilia has a Response Code but it is usable only with the Group Query Code. This means that only the Privacy Template PT3 is relevant to Cecilia.

With reference to FIG. 12, it should be noted that there is another way to create group related Query and Response Codes in Restricted Direct Discovery Model B. Instead of having a separate Query Code for a group, the Query Code can also be built in the way that it identifies both the individual and the group. In this variant, Bob would be asking by sending such Query Code e.g. “Is the police called Alice in proximity”, and Cecilia could respond by her Response Code saying “I saw you were looking for a police, I am Cecilia”. This means that the Mask in the Discoverer side need not to be a constant all 1's (i.e. “11111111”) but could also filter queries related to certain groups (e.g. “11110000”).

With reference to FIG. 12, it should also be noted that there is another way to assign Privacy Templates to group related discovery in Restricted Direct Discovery Model B. Instead of protecting the response to a group related query using the group related Privacy Template, the Discoveree could use her personal Privacy Template in her response. In this way only those Discoverers who know the personal Privacy Template are able to decrypt the Response Code.

In this case, in step 123 of FIG. 12, Alice would encrypt the Response Code using PTM(PT4) instead of PTM(PT3). Similarly, in step 124, Bob would decrypt the Response Code from Alice using PTM(PT4) instead of PTM(PT3).

Thus, these examples demonstrate that the described solution works also in the case that the monitoring/discoverer UE and the announcing/discoveree UE do not share exactly the same ProSe code but instead share only a fragment of one.

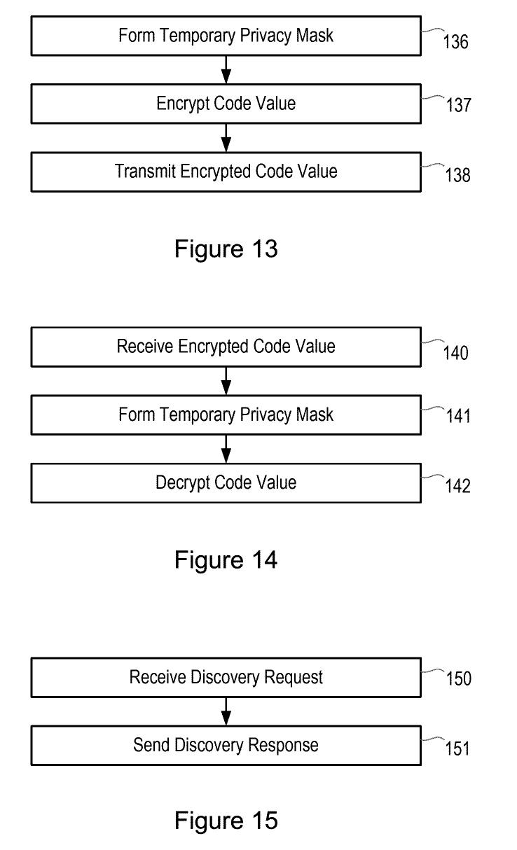

FIG. 13 is a flow chart, summarizing a method performed in a UE that transmits an encrypted code.

In step 136, the UE forms a temporary privacy mask using a time-varying value and a privacy template. In step 137, the UE encrypts a code value using the temporary privacy mask. In step 137, the UE transmits the encrypted code value.

FIG. 14 is a flow chart, summarizing a method performed in a UE that receives an encrypted code.

In step 140, the UE receives an encrypted code value. In step 141, the UE forms a temporary privacy mask using a time-varying value and a privacy template. In step 142, the UE decrypts the code value using the temporary privacy mask.

FIG. 15 is a flow chart, summarizing a method performed in a network node. In step 150, the network node receives a discovery request from a device. In step 151, the network node sends a discovery response to the device, wherein the discovery response includes at least one privacy template.

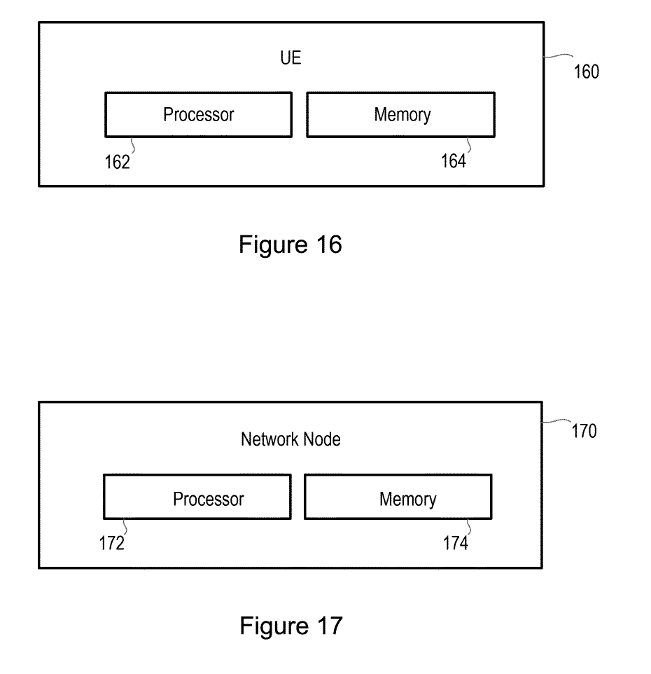

FIG. 16 illustrates a UE 160, comprising a processor 162 and a memory 164. The memory 164 contains instructions executable by the processor 162, such that the UE 160 is operative to carry out any of the methods described herein, for example the methods shown in FIG. 13 or 14.

FIG. 17 illustrates a network node 170, comprising a processor 172 and a memory 174. The memory 174 contains instructions executable by the processor 172, such that the network node 170 is operative to carry out any of the methods described herein, for example the method shown in FIG. 15.

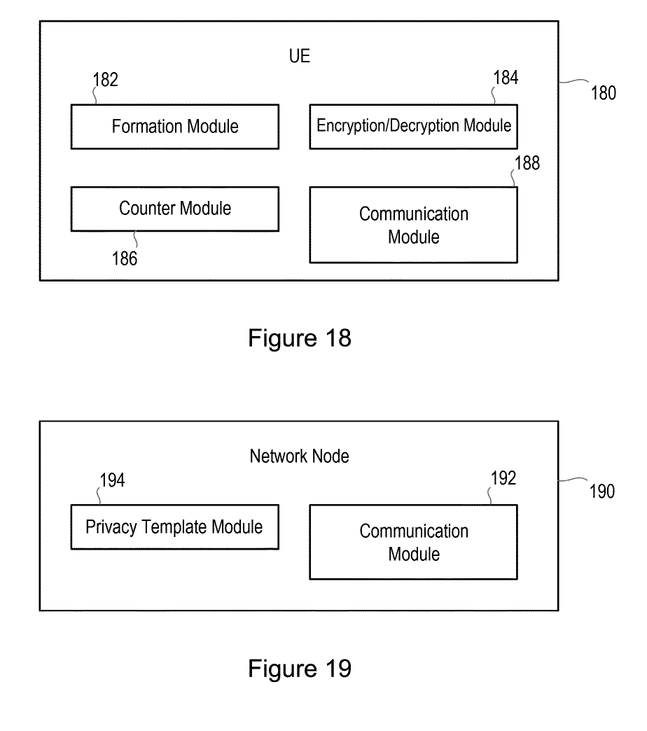

FIG. 18 illustrates functional units in another embodiment of a UE 180 which may execute any of the methods described herein, for example the methods shown in FIG. 13 or 14, for example according to computer readable instructions received from a computer program. It will be understood that the units illustrated in FIG. 18 are software implemented functional units, and may be realised in any appropriate combination of software modules.

Referring to FIG. 18, the UE 180 comprises a formation module 182 for forming a temporary privacy mask using a time-varying value and a privacy template; an encryption/decryption module 184 for encrypting a code value using the temporary privacy mask and/or for decrypting a received encrypted code value using the temporary privacy mask; a counter module 186 for generating the time-varying value; and a communication module 188 for transmitting an encrypted code value and/or receiving an encrypted code value.

The communication module 188 may also comprise means for receiving the privacy template from a network node.

FIG. 19 illustrates functional units in another embodiment of a network node 190 which may execute any of the methods described herein, for example the method shown in FIG. 15, for example according to computer readable instructions received from a computer program. It will be understood that the units illustrated in FIG. 19 are software implemented functional units, and may be realised in any appropriate combination of software modules.

Referring to FIG. 19, the network node 190 comprises a communication module 192, for receiving a discovery request from a device, and/or sending a discovery response to the device; and a privacy template module 194, for forming at least one privacy template, for inclusion in the discovery response.

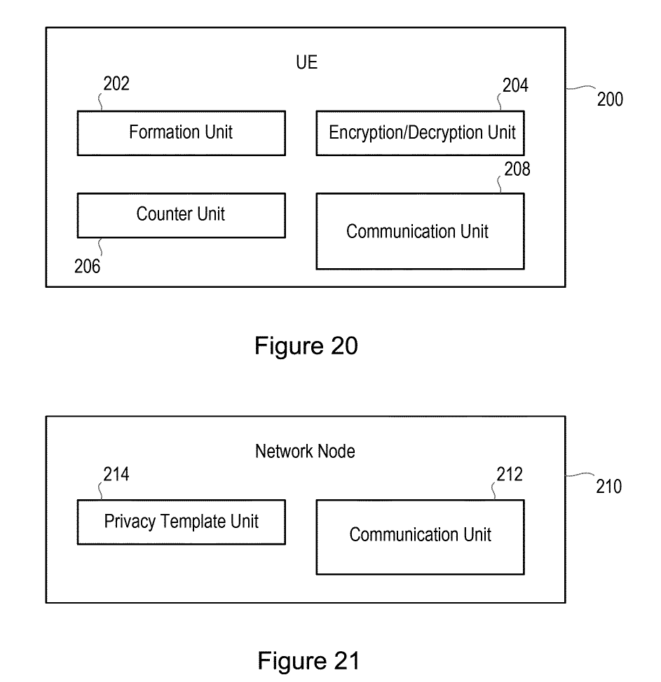

FIG. 20 illustrates functional units in another embodiment of a UE 200 which may execute any of the methods described herein, for example the methods shown in FIG. 13 or 14, for example according to computer readable instructions received from a computer program. It will be understood that the units illustrated in FIG. 20 are hardware implemented functional units, and may be realised in any appropriate combination of hardware elements.

Referring to FIG. 20, the UE 200 comprises a formation unit 202 for forming a temporary privacy mask using a time-varying value and a privacy template; an encryption/decryption unit 204 for encrypting a code value using the temporary privacy mask and/or for decrypting a received encrypted code value using the temporary privacy mask; a counter unit 206 for generating the time-varying value; and a communication unit 208 for transmitting an encrypted code value and/or receiving an encrypted code value.

The communication unit 208 may also comprise a unit for receiving the privacy template from a network node.

FIG. 21 illustrates functional units in another embodiment of a network node 210 which may execute any of the methods described herein, for example the method shown in FIG. 15, for example according to computer readable instructions received from a computer program. It will be understood that the units illustrated in FIG. 21 are hardware implemented functional units, and may be realised in any appropriate combination of hardware units.

Referring to FIG. 21, the network node 210 comprises a communication unit 212, for receiving a discovery request from a device, and/or sending a discovery response to the device; and a privacy template unit 214, for forming at least one privacy template, for inclusion in the discovery response.

Aspects of the present invention thus provide methods, apparatus and computer programs enabling encryption and decryption of code values, based on shared secrets. The shared secret can be transmitted from a network node.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. A method, comprising:
forming a temporary privacy mask using a time-varying value and a privacy template;
encrypting a code value using the temporary privacy mask; and
transmitting the encrypted code value.

2. The method of claim 1, wherein the time-varying value is a counter.

3. The method of claim 2, wherein the counter is a time-based counter.

4. (canceled)

5. The method of claim 1, wherein the time-varying value is a Message Integrity Code associated with the code value.

6. The method of claim 1, further comprising receiving the privacy template prior to forming the temporary privacy mask.

7-9. (canceled)

10. The method of claim 1, wherein forming the temporary privacy mask comprises applying a hash function to the counter value and the privacy template.

11. (canceled)

12. The method of claim 1, wherein encrypting the code value using the temporary privacy mask comprises performing an XOR operation on the code value and the temporary privacy mask.

13. The method of claim 1, wherein encrypting the code value comprises encrypting a part of the code value and leaving a part of the code value unencrypted.

14-15. (canceled)

16. The method of claim 1, wherein the code value identifies an individual and the code value is confidentiality protected using the privacy template specific to the individual.

17-21. (canceled)

22. A user equipment device, configured to:
form a temporary privacy mask using a time-varying value and a privacy template;
encrypt a code value using the temporary privacy mask; and
transmit the encrypted code value.

23. A user equipment device, comprising a processor and a memory, the memory containing instructions executable by the processor, such that the user equipment device is operable to carry out the method of claim 1.

24. A method, comprising:
forming a temporary privacy mask using a time-varying value and a privacy template;
receiving an encrypted code value; and
decrypting the code value using the temporary privacy mask.

25. The method of claim 24, wherein the time-varying value is a counter.

26. The method of claim 25, wherein the counter is a time-based counter.

27. (canceled)

28. The method of claim 24, further comprising receiving the privacy template prior to forming the temporary privacy mask.

29-31. (canceled)

32. The method of claim 24, wherein forming the temporary privacy mask comprises applying a hash function to the counter value and the privacy template.

33. (canceled)

34. The method of claim 24, wherein decrypting the code value using the temporary privacy mask comprises performing an XOR operation on the encrypted code value and the temporary privacy mask.

35. The method of claim 24, further comprising testing whether the decrypted code value is recognized by comparing at least a part of the decrypted code value with a stored code value.

36. The method of claim 35, further comprising:
applying a mask to the decrypted code value;
applying said mask to the stored code value; and
determining whether the result of applying the mask to the decrypted code value matches the result of applying the mask to the stored code value.

37. The method of claim 24, wherein the code value identifies an individual and the code value is confidentiality protected using the privacy template specific to the individual.

38-42. (canceled)

43. A user equipment device, configured to:
form a temporary privacy mask using a counter value and a privacy template;
receive an encrypted code value; and
decrypt the code value using the temporary privacy mask.

44. A user equipment device, comprising a processor and a memory, the memory containing instructions executable by the processor, such that the user equipment device is operable to carry out the method of claim 24.

45-54. (canceled)

55. A computer program configured, when run on a computer, to carry out the method of claim 1.

56. (canceled)
